(19) United States
(12) Patent Application Publication
(10) Pub. No.: US 2011/0167034 A1
(43) Pub. Date: Jul. 7, 2011

(54) SYSTEM AND METHOD FOR METRIC BASED ALLOCATION OF COSTS

(75) Inventors: Timothy Knight, Escondido, CA (US); Myles Suer, Carlsbad, CA (US)

(73) Assignee: HEWLETT-PACKARD DEVELOPMENT COMPANY, L.P., Houston, TX (US)

(21) Appl. No.: 12/916,435

(22) Filed: Oct. 29, 2010

Related U.S. Application Data
(63) Continuation-in-part of application No. 12/652,424, filed on Jan. 5, 2010.

(51) Int. Cl. G06F 17/30

(52) U.S. Cl. 707/602; 707/E17.044

(57) ABSTRACT

Systems, methods and computer-readable storage media are provided for automatically allocating resources based on metrics. A plurality of metric values related to a respective plurality of dimensions may be determined. A resource may be allocated to the plurality of dimensions based on the plurality of metric values. Other embodiments are described and claimed.

### CLAIM OF PRIORITY

This application is a continuation-in-part, and claims the benefit of priority, under 35 U.S.C. §120, of U.S. patent application Ser. No. 12/652,424, filed Jan. 5, 2010, titled “ALLOCATING RESOURCES IN A DATA WARE HOUSE”.

### BACKGROUND

Information technology (IT) organizations or departments may represent the largest single capital expenditure, yet non-revenue bearing, cost inside most large enterprises. Accordingly, enterprise business customers are placing new demands on IT organizations.

IT organizations may be required to demonstrate and quantify the value they offer. For example, IT organizations may now be required to allocate costs fairly and upon measured facts. This requires that IT organizations be able to relate costs to categorizations or parameters that make sense to business leaders, and do more than simple spreading of costs.

However, an information technology (IT) organization may need to be able allocate costs by metrics that may not exist in an out-of-the-box product and may further be required to do it at all levels of an enterprise. For example, an IT organization may be required to allocate data center costs to IT services, IT service costs to business services or allocate service, program, and project costs to organizations.

Typically, costs are allocated based on data in a data warehouse where information or data related to costs is aggregated, e.g., in bills, invoices or reports. For example, data from websites, operational databases, spreadsheets, text files and user defined files may all be aggregated in a data warehouse and used for various costs calculations, including distributing or allocating costs within an enterprise.

Due to the diversity in sources and types of information in a data ware house, data in a data ware house may not be readily used in order to perform meaningful financial analysis or reporting, and in particular, cost allocation or distribution. For example, data in a data ware house typically lacks relationships to key dimensions of an enterprise such as projects, departments, services, organizations or other cost related categories.

Further aggravating the problem is the fact that financial cost data in a data warehouse also often lacks required granularity. For example, a utility bill for a single corporate building will arrive as a single amount, but the costs may need to be shared by the different organizations within the building. Other examples may be costs for shared services such as network bandwidth usage, email, and server space consumption that may need to be apportioned to different projects or departments within an organization.

In addition, financial analysts may need to assign costs based on factors that may change regularly, such as organizational headcount, either total server space consumption or per project server space consumption, network nodes and the like. Financial analysts need a way to attribute these costs to the different departments, projects, organizations or other dimensions or entities of an enterprise in a way that is fair and/or makes sense for the business. However, currently available systems and/or methods do not provide or enable such capacity.

Currently, distribution of costs is handled ad-hoc, using spreadsheets or manually-created formulas. However, manual methods are time consuming, costly and error prone and fixed formulas become out of date, in times, as soon as they are created, because the factors on which they are based (e.g., headcount, network nodes etc.) are constantly changing.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 depicts a system in accordance with an embodiment of the invention;

FIG. 2 depicts a method in accordance with an embodiment of the invention;

FIG. 3 depicts a Graphical User Interface (“GUI”) in accordance with an embodiment of the invention;

FIG. 4 depicts a GUI in accordance with an embodiment of the invention;

FIG. 5 depicts a GUI in accordance with an embodiment of the invention;

FIG. 6 depicts a GUI in accordance with an embodiment of the invention; and

FIG. 7 depicts a system in accordance with an embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Embodiments in accordance with the invention may solve problems discussed above by automatically allocating, distributing or dividing costs based on metrics, weights or other parameters. Embodiments in accordance with the invention may automatically allocate, divide or distribute costs based on metrics that may be dynamic and/or user defined. A system and/or method of metric based allocation in accordance with embodiments of the invention as described herein may provide a straightforward way for financial analysts to allocate or distribute costs based on any defined metric. As described herein, metrics may be dynamically defined, modified and/or added to, or removed from, a system.

A metric as referred to herein may be, for example, a number of service requests, a headcount, a number of servers or server space, a network nodes, a network bandwidth or any number or parameter that may be associated with a dimension of an organization and used in order to calculate a share of a cost of such dimension. For example, a metric related to a number of service requests associated with each department in an organization may be used to divide a cost of IT services between a number of departments in an organization. Likewise, a metric related to, or associated with, a headcount of departments may be used to determine the relative cost of an internet connection that each department is to pay.

Embodiments in accordance with the invention may be or may include a system and/or method for distributing or allocating and/or reallocating or redistributing costs or resources in a data warehouse to improve analysis and reporting capabilities. Some embodiments in accordance with the invention may be provided in an article comprising a computer program product that may include a machine-readable medium, stored thereon instructions, which may be used to program a computer, or other programmable devices, to perform methods as described herein. Other embodiments in accordance with the invention may include an article comprising a computer readable medium having stored thereon instructions which when executed by a processor cause the processor to perform the method described herein.

An original table of resources may be retrieved from the data warehouse. Records in the original table of resources may have data that describes a resource. The records of the original table of resources may be reserved, allocated and reallocated to records of various destination tables based on one or more metrics or rules that may be associated with one or more metrics or stages of a scenario. A rule may include source criteria, which determine which records of resources are to be reserved, target criteria, which may determine the destination of the reserved records of resources. A rule may include or be associated with one or more metrics that may be applied to records. A metric may be associated with a cost or a record and may be used to allocate, divide or distribute a cost. For example, a cost of a service or a resource may be divided between a number of entities based on one or more metrics that may be associated with one or more entities of an organization. Various operations performed on records may be dictated by a metric, for example, operations such as selecting specific records or fields in a record, modifying records, generating new records, filtering records etc. may be performed based on one or more metrics.

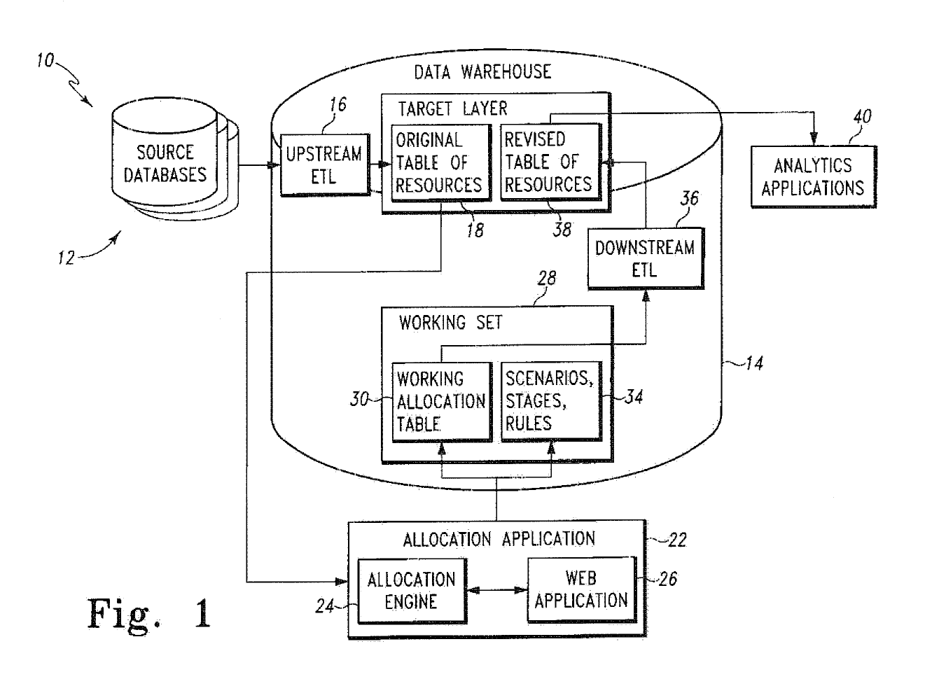

Reference is now made to FIG. 1, which shows an exemplary system 10 that may be used to allocate and/or distribute costs or resources according to embodiments of the invention. System 10 may be associated with a data warehouse 14 and may be operatively connected to sources databases 12 and analytics applications 40. System 10 may include an upstream extract, transform and load (ETL) component 16 and a downstream ETL component 36 and a target layer including original table of resources 18 and revised table of resources 38. System 10 may include a working set 28 component which may include a working allocation table 30 and one or more scenarios, stages and rules 34. System 10 may include or be operatively connected to allocation application 22 that may include application engine 24 and web application 26.

Upstream ETL component 16 may extract, transform and load data from one or more data sources 12 to data warehouse 14 in a normalized form. Data sources 12 may include any number of data sources that may be homogeneous or heterogeneous data sources, such as operational databases, spreadsheets, text files, emails, web pages, and other computer files. Applicable components of system 100, e.g., the one or more data sources 12, application engine 24 and web application 26, data warehouse 14 and/or any other applicable component described herein may be in communication over one or more wired or wireless computer networks e.g., LANs, WANs such as the Internet.

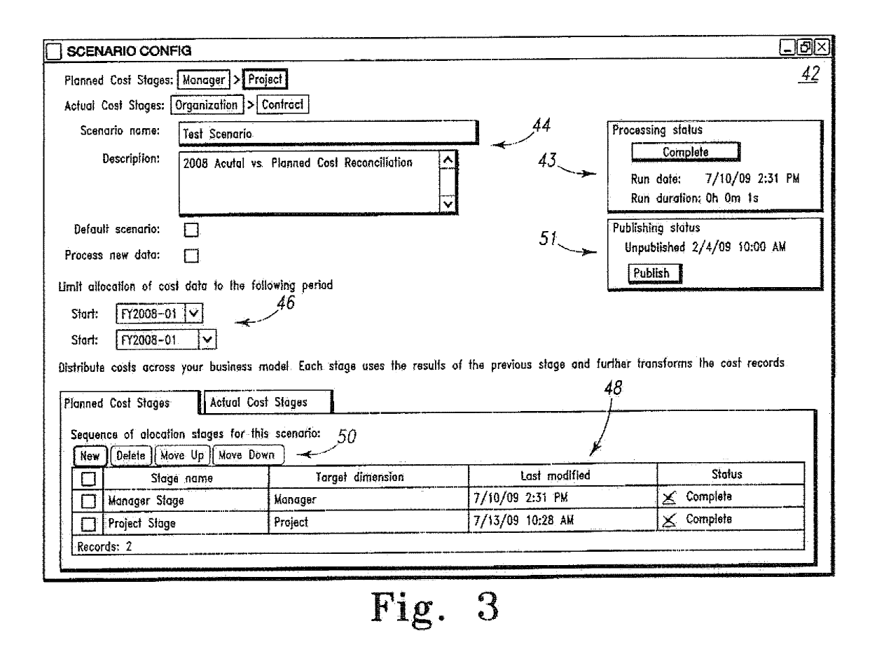

Information in original table of resources 18 may be retrieved from data warehouse 14. Original table of resources 18 may include one or more records, each having data that describes a resource to be allocated. The data in each record may be characterized by one or more dimensions. For example, a record may describe a resource that is allocated to a particular organization. Original table of resources 18 may be retrieved from data warehouse 14 by an allocation application 22. Allocation application 22 may include an allocation engine 24 and web application 26 that may be any suitable application interface. In some embodiments, allocation application 22 may be a computer program, executing on one or more computer processors. Allocation application 22 may be configured to cause allocation engine 24 (which may be a similar computer program) to perform processing of data in original table of resources 18 in order to allocate resources or distribute costs to one or more destination tables. Allocation application interface 26 may be a user interface usable to control components of system 10, e.g., allocation engine 24 and/or allocation application 22. Allocation application interface 26 may include a traditional GUI, a command line interface or a web-based interface. Examples of GUIs that may be usable to configure and control allocation application 22 are shown in FIGS. 3, 4, 5 and 6.

Allocation engine 24 may execute separately and/or asynchronously from the allocation application interface 26. Allocation engine 24 may be configured to respond to various events generated at the allocation application interface 26. Allocation engine 24 may perform operations on data in working set 28. Working set 28 may include a working allocation table 30 and one or more scenarios, stages and rules 34.

Allocation engine 24 may be configured to allocate or distribute data from original table of resources 18 into working allocation table 30, as well as reallocate and/or redistribute resources or costs within working allocation table 30. For example, based on scenarios, stages and rules 34, records in working allocation table 30 may be modified and/or new records in working allocation table 30 may be created.

Allocation engine 24 may provide allocated or distributed resources or costs to downstream ETL 36 that may write records or other data into revised table of resources 38. Revised table of resources 38 may be available to various analytics applications 40. A scenario may include one or more stages, and a stage may include one or more rules with source and target criteria. Users may design scenarios in order to revise records or data to be more useful for analytics and reporting. A scenario may be created with a particular purpose, which may be creating revised fact data that is suitable for a particular user's needs. For example, a user may wish to compare actual expenditures against planned expenditures, by organization or a user may wish to distribute costs based on headcount, time of day when a resource is used, number of items delivered to a department etc. For example, in the case of comparing actual expenditures to planned expenditures, if these two types of information are derived from different sources, the user may find that planned expenditures are categorized by organization and actual expenditures are categorized by project. According to embodiments of the invention, the user may create a scenario that allows for derivation of the organization from the project. The results may be stored back in revised table of resources 38 so that it is available to various applications, such as analytics applications 40 of FIG. 1.

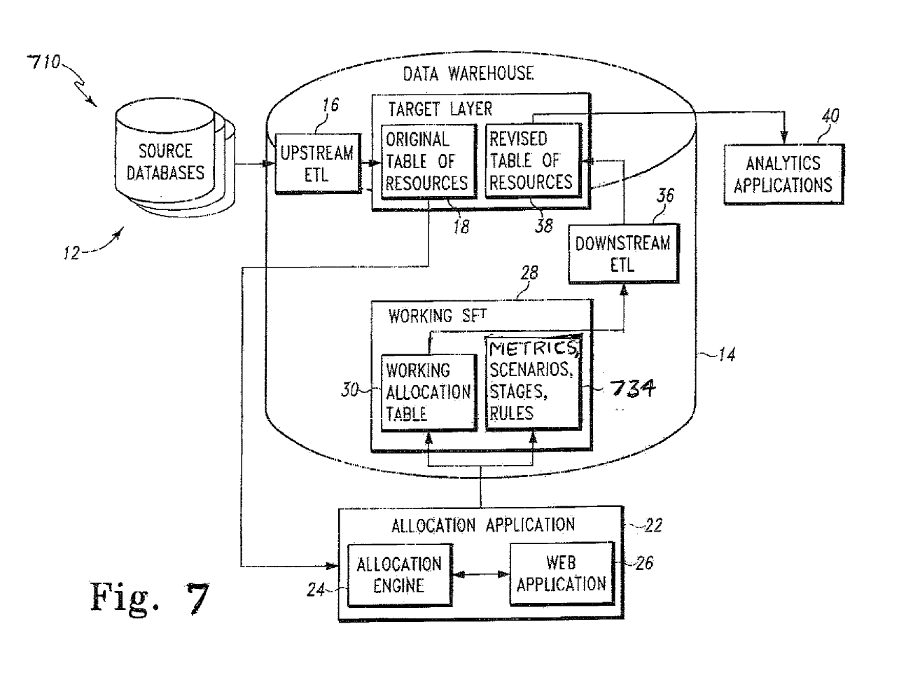

Reference is additionally made to FIG. 7, which shows an exemplary system 710 that may be used to allocate and/or distribute costs or resources according to, or based on, metrics and/or scenarios, staged or rules as described herein. As shown, system 710 may include components similar to those included in system 10 described herein, e.g., with respect to FIG. 1. System 710 may include one or more metrics, scenarios, stages and rules 734. Metrics as shown by 734 in FIG. 7 may be associated with a cost and may be used to allocate, divide or distribute a cost as described herein. For example, a cost of a service such as storage or a resource such as network bandwidth may be divided between a number of entities, e.g., a number of departments, based on one or more metrics that may be associated with one or more resources or costs. Various operations performed on records may be dictated by metrics shown by 734. Generally, system 710 may be realized by adding metrics to system 10 described herein. In particular and as shown, by adding metrics to element 34 in system 10, element 734 in system 710 may be realized. Accordingly, references to elements or components of system 10 may be applicable similar elements of system 710 and vice versa.

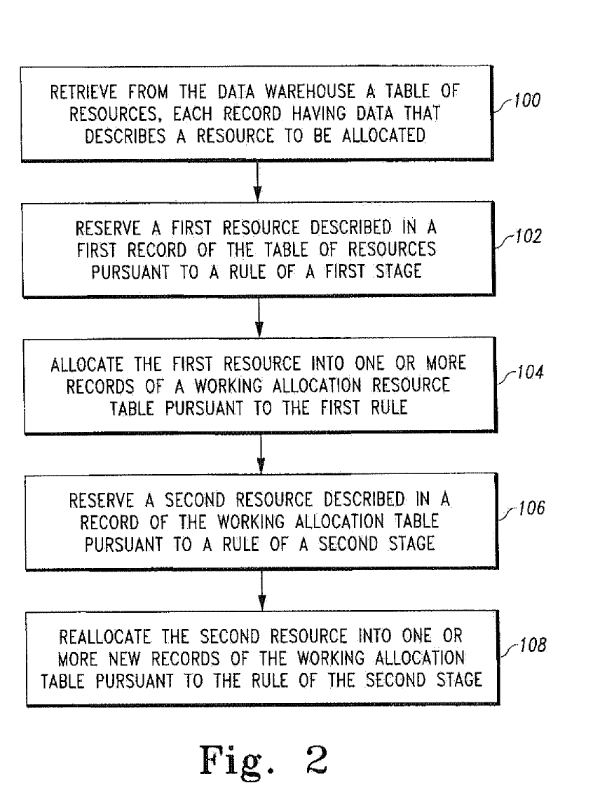

Reference is now made to FIG. 2, which shows an exemplary method of allocating resources in a data warehouse that may be performed by an allocation engine (e.g., 24 in FIG. 1). Although these steps are shown in a particular sequence, it should be understood that these steps may be performed in other sequences, with steps being omitted, duplicated, rearranged and/or performed simultaneously in some cases. In step 100, an original table of resources is retrieved from the data warehouse. The table may include a one or more records, each record possibly having data that describes a resource to be allocated.

In step 102, a first resource described in a first record of the table of resources is reserved pursuant to a first rule or criteria that may be associated with a first stage. Although only a single resource in a single record of a table of resources is shown in FIG. 2 being reserved by the first rule, a second resource described in a second record of the table of resources may be reserved pursuant to the first rule. The records that are reserved may be determined based on source criteria of the rule, which may return multiple records of resources. For example, if a rule calls for resources having a DEPT_ID equal to 10, then all records of resources that have a DEPT_ID==10 will be reserved. The example application described below includes such an occurrence.

Step 102 may include creating or adding data to an allocation reservation table. An allocation reservation table may track records of resources that have been reserved, preventing later attempts to reserve the same resources. For example, an identifier associated with the first record reserved in step 102 may be stored in an allocation reservation table to indicate that the record with data describing the first resource has been reserved. An example of an allocation reservation table is discussed in an example application below. In some embodiments, records in a working allocation table may be created, modified or manipulated based on one or more metrics described herein.

In step 104, the first resource reserved in the table of resources in step 102 is allocated into one or more records of a working allocation table pursuant to target criteria of a rule of the first stage. The number of records into which the first resource is allocated, as well as the amount of the resource that is allocated to each record, may depend on the target criteria of the rule. Once all rules of a stage are processed by the allocation engine, subsequent stages of rules may be applied or processed in association with records. In some embodiments, once all rules of a first stage are processed and the resources described in the original table of resources (e.g., 18 in FIG. 1) are allocated into a working allocation table (e.g., 30 in FIG. 1), rules in subsequent stages may be applied or processed using the data from the working allocation table (e.g., 30 in FIG. 1), rather than the original table of resources retrieved from the data warehouse. In some embodiments, resources may be reallocated into one or more new records of the working allocation table. Examples of this are seen in the example application discussed below.

In step 106, a second resource is reserved or entered (e.g., as part of a record) pursuant to a rule of a second stage. Because the method is past the first stage, the records that are created, entered or reserved may be records of a working allocation table. Rules of each stage after the first stage may reserve records from the working allocation table and reallocate the reserved resources back into new records of the working allocation table. For example, in step 108, the second resource described in the record of the working allocation table reserved in step 106 is reallocated into one or more new records of the working allocation table pursuant to the rule of the second stage.

Eventually, data allocated from the original table of resources 18 into a working allocation table 30, and data reallocated from the working resources table 30 back into new records of the working resources table 30, may be written back into data warehouse for analytics and reporting. For example, data from records of the working allocation table 30 that were created in a final stage of a series of stages in a scenario may be written back to a data warehouse by the downstream ETL component 36 of FIG. 1. In some examples, the stage during which a record of the working allocation table was added may be stored in the record, so that records added during the final stage are easily discernable.

An exemplary set of rules associated with a set of exemplary stages is described below. The exemplary implementation described below is one of many possible implementations and should not be construed as limiting other embodiments of the invention. An exemplary scenario may be created with the following stages and rules:
Stage 1: Department
Rule 1:
Source Criteria: dept_id=1 or dept_id=3
Target Criteria: dept_id->2 percentage: 100% formula: amount*2.50
Rule 2:
Source Criteria: dept_id is null Target Criteria: dept_id->5
Rule 3:
Copy remaining (catch-all rule)
Stage 2: Location
Rule 1:
Source Criteria: location_id is null
Target Criteria: location_id->88 (50%); 99 (50%)
Rule 2:
Copy remaining (catch-all rule)

Now, assume that an original table of resources (e.g., 18 in FIG. 1) has been retrieved from data warehouse that contains the following records:

| COST_ID | AMOUNT | DEPT_ID | ASSET_ID | LOC_ID |
|---|---|---|---|---|
| 1 | 10 | 1 | 5 | |
| 2 | 15 | 3 | 5 | |
| 3 | 4 | 2 | | 8 |
| 4 | 2 | | 4 | 8 |
| 5 | 75 | 5 | 4 | 8 |

Rule 1 of the first stage of the example scenario searches for any resource (i.e. a record) where the DEPT_ID is equal to 1 or 3. That captures records 1 and 2 of the table of resources, above. To reserve these records and prevent them from being reused, the following information may be added to an allocation reservation table:

| ID | COST_ID | STAGE_ID | RULE_ID |
|---|---|---|---|
| 1 | 1 | 1 | 1 |
| 2 | 2 | 1 | 1 |

The following records may be added to a working allocation table (e.g., 30 in FIG. 1) in accordance with the Target Criteria of Rule 1 of Stage 1:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |

As shown in the table above (that may be a working allocation table as described herein), 100% of each resource reserved from the table of resources that has a DEPT_ID of either 1 or 3 is multiplied by 2.5 (10×2.5=25; 15×2.5=37.5) and allocated to the department having DEPT_ID=2. The next rule, Rule 2 of Stage 1, seeks all records of resources where the DEPT_ID is null, and allocates them to the department having the DEPT_ID equal to 5. This will reserve record 4 of the table of resources. Accordingly, after Rule 2 of stage 1 is applied, an allocation reservation table may look like this:

| ID | DEPT_ID | SRTAGE_ID | RULE_ID |
|---|---|---|---|
| 1 | 1 | 1 | 1 |
| 2 | 2 | 1 | 1 |
| 3 | 4 | 1 | 2 |

A third record would be added to the working allocation table as shown below:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |
| 3 | 2 | 5 | 4 | 8 | 1 | 2 |

Rule 3 of Stage 1 is a catch-all rule that is intended to reserve all remaining resources from the table of resources, which are the resources described in records 3 and 5, for allocation into the allocated resources table. No changes are made to the allocation reservation table in this example. Thus, the working allocation table will appear as follows after processing of Stage 1, Rule 3:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |
| 3 | 2 | 5 | 4 | 8 | 1 | 2 |
| 4 | 4 | 2 | | 8 | 1 | 3 |
| 5 | 75 | 5 | 4 | 8 | 1 | 3 |

In stage 2 and all subsequent stages, resources are no longer reserved from the table of resources. Rather, records may be reserved from the working allocation table (e.g., 30 in FIG. 1) and reallocated back into the working allocation table. Rule 1 of Stage 2 seeks all records where the LOC_ID is null, which in this example captures the records of the working allocation table having COST_ID equal to 1 and 2. Rule 1 next dictates that 50% of the reserved resources (25 and 37.5, respectively) should be reallocated to the location having LOC_ID=88, and the other 50% is to be reallocated to a location having a LOC_ID=99. After processing of Stage 2, rule 1 is complete, the allocation reservation table will look like this:

| ID | COST_ID | STAGE ID | RULE_ID |
|---|---|---|---|
| 1 | 1 | 1 | 1 |
| 2 | 2 | 1 | 1 |
| 3 | 4 | 1 | 2 |
| 4 | 1 | 2 | 1 |
| 5 | 2 | 2 | 1 |

The allocated resources table would look like this:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |
| 3 | 2 | 5 | 4 | 8 | 1 | 2 |
| 4 | 4 | 2 | | 8 | 1 | 3 |
| 5 | 75 | 5 | 4 | 8 | 1 | 3 |
| 6 | 12.5 | 2 | 5 | 88 | 2 | 1 |
| 7 | 12.5 | 2 | 5 | 99 | 2 | 1 |
| 8 | 18.75 | 2 | 5 | 88 | 2 | 1 |
| 9 | 18.75 | 2 | 5 | 99 | 2 | 1 |

Rule 2 of stage 2 is another catch-all rule that reallocates into the working allocation table all records in the working allocation table that were not reallocated during stage 2. The resulting working allocation table will look like this:

| COST_ID | AMOUNT | DEPT_ID | ASSET_ID | LOC_ID | STAGE_ID | RULE_ID |
|---|---|---|---|---|---|---|
| 1 | 25 | 2 | 5 | | 1 | 1 |
| 2 | 37.5 | 2 | 5 | | 1 | 1 |
| 3 | 2 | 5 | 4 | 8 | 1 | 2 |
| 4 | 4 | 2 | | 8 | 1 | 3 |
| 5 | 75 | 5 | 4 | 8 | 1 | 3 |
| 6 | 12.5 | 2 | 5 | 88 | 2 | 1 |
| 7 | 12.5 | 2 | 5 | 99 | 2 | 1 |
| 8 | 18.75 | 2 | 5 | 88 | 2 | 1 |
| 9 | 18.75 | 2 | 5 | 99 | 2 | 1 |
| 10 | 2 | 5 | 4 | 8 | 2 | 2 |
| 11 | 4 | 2 | | 8 | 2 | 2 |
| 12 | 75 | 5 | 4 | 8 | 2 | 2 |

As demonstrated by this example, each stage may operate on records of the working allocation table that were created during the previous stage. To track stages, the stage during which a record of the working allocation table was created may be stored in the record.

Once data has been allocated (and reallocated, e.g., if there are multiple stages in a scenario) into a working allocation table, data from the working allocation table may be written back into the data warehouse. The final results of a scenario may be the records in the working allocation table that have the final stage number of the scenario. In the example above, all the records of the working allocation table having a STAGE_ID of 2 (i.e., the final stage of the example scenario) may be written back to the data warehouse as a revised table of resources (e.g., 38 in FIG. 1). Analytics and reporting may be performed using these revised resources.

As noted above, the allocation engine may be responsive to the allocation application interface. Changes to a scenario, including changes to its stages or rules, may immediately prompt the allocation engine to process the scenario. The following are examples of events at the allocation application interface that may prompt the allocation engine to process a scenario:

Creating a new rule;

Changing an existing rule;

Changing the sequence of rules within a stage;

Changing the sequence of stages in a scenario;

Inserting a new stage before an existing stage;

Deleting a scenario;

Deleting a stage;

Deleting a rule; and

Changing a scenario's start/end dates.

Possibly in addition to, or instead of, a rule-based distribution of costs as described herein, metric based distribution or allocation of costs may be provided and/or enabled by embodiments of the invention. Embodiments of the invention enable cost apportionment, cost assignment, cost distribution, attribution and/or cost reapportionment according to one or more metrics or weights. For example, instead of spreading costs according to fixed percentage or a predefined share, costs can be distributed, allocated or divided according to, or based on, metric values. Accordingly, fairer cost distribution or division of costs may be achieved. In some embodiments, metrics can be entered manually, e.g., using a GUI application similar to the GUI application described herein, e.g., with respect to FIGS. 3-6. An automated procedure, flow or method may utilize metrics to distribute costs between an organization's dimensions such as departments, projects, locations or any other applicable entities. As referred to herein, an organization's or an enterprise's dimension may be any part, element or entity of an organization or enterprise. As described herein, embodiments of the invention may determine a plurality of values (or metric values) of a selected metric for each of a respective plurality of records. For example, values (or metric values) of a selected metric may be determined for each record in working allocation table 30 that may be related to a respective set of dimensions of an enterprise as described herein. Such determined values may be associated with the respective dimensions, e.g., by associating the values with, or inserting the values into the respective records. A resource or a cost may be allocated to one or more records (or the related dimensions) based on the associated values. For example, a rule may distribute a cost or allocate a resource based on an associated value or metric value.

For example, two departments in an organization may share a cost related to headcount (e.g., IT services, transportation of employees etc.) and the respective headcounts of the two departments may vary from month to month. According to embodiments of the invention, costs for each month may be distributed to, or divided between, the two departments according to their respective true or current headcount. For example, using a metric related to headcount as further described herein, a monthly cost of food provided to employees may be distributed between the two departments according to their headcount in the relevant month. In such case, a metric related to a headcount may be associated with the two departments, a metric value may be determined for each department, and the cost may be divided between the departments based on the metric value.

A system according to embodiments of the invention may utilize metrics and metrics values to divide or distribute costs based on metrics and/or metrics values. By utilizing metrics as described herein, users may define a distribution of costs, e.g., costs as obtained from a data warehouse. As described herein, costs may be distributed to, or associated with, new entities, e.g., departments or organizations, that may be created, defined or introduced subsequent to a definition, incorporation or implementation of a metric. For example, a specific cost may be distributed or allocated to departments in an organization based on the number of computers in each department. At a first period of time, a metric related to the number of computers in each department may be used to divide a cost between three departments. At a second period of time, in which a new department was added to the organization, the cost may be automatically divided between four departments (the three old departments and the new department) by associating each department, including the newly introduced department, with a cost that reflects each department's number of computers as related to the total number of computers in the organization.

In another example, the respective headcount of three departments in an organization may be 30, 30 and 40. A metric related to headcount (that may be associated with each department) may cause a respective cost distribution of 30%, 30% and 40% between the departments. For example, the cost of electric power, food, IT services and the like may be thus distributed or divided. Next, a new department of 20 employees may be added to the organization and it may be determined that the new department is to share the cost with the existing departments. Accordingly, a metric based cost allocation may now automatically cause a respective distribution or allocation of 25%, 25%, and 33% of the cost to the three existing departments and a share of 16.5% of the cost to the new department.

An open-ended user interface may allow a user to define new metrics or modify existing metrics and provide such new or modified metrics to a system in real-time. Metrics may be provided to a system online or on-the-fly, accordingly, new or modified metrics may be provided to a system (e.g., system 10) without interrupting the system's operations. A system may, in real time, receive new metrics and process data as described herein including data that may have been stored in the system prior to receiving the new or modified metrics. Accordingly, a new distribution, redistribution or reallocation of costs may be performed based on existing data in a data warehouse. In some embodiments, providing a system with new or modified metrics and/or new data related to cost may automatically trigger a reallocation, distribution or a redistribution of costs according to the new metrics and based on existing data. For example, even though the respective headcounts of a number of departments in an organization may remain constant, modifying or adding a metric as described herein may trigger a process as described herein that may change a distribution of costs related to the headcount. Accordingly, users of a system described herein may need not constantly update rules or configure a system as things changed. For example, a metric may be applied to any department in an organization, including departments added after the metric has been configured and/or incorporated in a system as described herein.

Embodiments of the invention may include means to dynamically distribute costs based on weighting factors or metrics that may be related to dynamic parameters. For example, a metric may be or may be related to headcount, power consumption, server space usage, number of network nodes, network bandwidth and/or other user-defined metrics. Values or numbers associated with metrics may change over time or vary from period to period (e.g., month, quarter, year). For example, a metric may be related to a headcount which may vary over time. For example, a cost of work done by an IT department may be divided between departments based on the departments' headcounts (e.g., assuming IT personnel assistance and time devoted to a specific department is proportional to the number of employees in the department). Accordingly, an IT cost (or cost share or percentage) associated with a department may automatically vary according to the headcount Likewise, the cost or cost share or percentage associated with any resources or costs, e.g., data storage or network related costs may be derived according to one or more applicable metrics.

Metrics may be related to data in a data warehouse. For example, data loaded into a data warehouse may be from sources such as database tables or spreadsheets that may include metric data. Metric data as referred to herein may be any data associated with a metric, e.g., headcount, number of nodes on a network or other infrastructure costs and the like. Metric data may be obtained form any applicable source such as financial systems, HR systems and/or operational reporting systems used by IT or other organizations or entities. In particular, spreadsheets including cost information may be particularly useful to most financial analysts because they are a medium commonly used. Accordingly, metric data may be extracted from spreadsheets or other information structures, included in records as described herein and metrics may be applied to such records in order to determine cost distributions or allocations.

Table I depicts an exemplary metric-based cost allocation implementation in accordance with an embodiment of the invention. This table is provided for explanatory purpose and is not to be construed as a limitation of embodiments of the invention. Data in the table below may be obtained from any applicable source, e.g., spreadsheets, flat files, and/or a database table, etc. An automated ETL process in accordance with an embodiment of the invention may transform data from a spreadsheet, table, and/or other source prior to importing data into the data warehouse. The ETL may source data to determine, calculate, and/or derive internal keys or values so that periods, numbers, amounts and dimensions in the table below relate to actual data in the data warehouse.

Values for different metrics, such as headcount, number of service requests or the square footage of a location can all be intermixed in the table below. Each row in a table in accordance with an embodiment of the invention may represent a metric value specific to a dimension, e.g. an organization (ORG) or location (LOC), a period (e.g., January 09), a particular entry in the dimension table (e.g. Sales, R&D, Cupertino), and/or an actual metric value, e.g., headcount of 20, 7 service requests, and 30,000 square feet as shown in the table below. The table below may be compiled as described herein, e.g., with respect to the rule based allocation in accordance with an embodiment of the invention (as described above).

Generally, the table below may be compiled as described herein, e.g., based on rules or logic that may be used to extract relevant data from source data. The table below or any other applicable structure may be generated by extracting data from a data warehouse, inserting records (e.g., rows) into the table and possibly further processing such records to generate new records that may be inserted into the table as described herein. For example, a dimension (that may be organization (ORG) or location (LOC) as shown), a time period, a dimension value (e.g., Sales, R&D or Cupertino as shown) may all be extracted from spreadsheets or other sources and inserted into the table below. A metric may be determined by defined metrics that may be stored, e.g., as shown by 734 in FIG. 1. Accordingly, allocation engine 24 may compile a table such as the table below. Based on a defined metric, the metric and metric value columns of the table below may be updated.

TABLE I

| | | | | | Metric |
|---|---|---|---|---|---|
| Id | Dimension | Metric | Period | Dim Value | Value |
| 1 | ORG | Headcount | January 2009 | Sales | 20 |
| 2 | ORG | Headcount | February 2009 | Sales | 21 |
| 3 | ORG | Headcount | March 2009 | Sales | 19 |
| 4 | ORG | Headcount | January 2009 | R&D | 150 |
| 5 | ORG | Headcount | February 2009 | R&D | 155 |
| 6 | ORG | Headcount | March 2009 | R&D | 155 |
| 7 | ORG | ServiceReqs | January 2009 | Sales | 7 |
| 8 | ORG | ServiceReqs | February 2009 | Sales | 3 |
| 9 | ORG | ServiceReqs | March 2009 | Sales | 1 |
| 10 | ORG | ServiceReqs | January 2009 | R&D | 18 |
| 11 | ORG | ServiceReqs | February 2009 | R&D | 13 |
| 12 | ORG | ServiceReqs | March 2009 | R&D | 25 |
| 10 | LOG | SquareFeet | January 2009 | Cupertino | 30000 |
| 11 | LOG | SquareFeet | February 2009 | Cupertino | 30000 |
| 12 | LOG | SquareFeet | March 2009 | Cupertino | 32000 |

Metric based rules may be defined, stored (FIG. 7, item 734) and used in conjunction with the table above. For example, a rule may be of the form: “For all utility costs that occurred in 2009, apportion to organizations based on the headcount metric”. Using Table Ie, if a $10,000 cost occurred in January 2009 such rule may cause utility costs to be divided between Sales and R&D as follows:
Sales: $10,000*(20/(20+150)), or $1176.47
R&D: $10,000*(150/(20+150)), or $8,823.53

The same metric based rule may cause utility costs in February 2009 to be divided differently since the headcount (and the related metric value) in February may be different from the headcount of January. Accordingly, the breakdown may be different:
Sales: $10,000*(21/(21+155)), or $1193.18
R&D: $10,000*(155/(21+155)), or $8,806.82

Accordingly, a metric based rule may provide automatic cost distribution based on a metric. The metric based rule described herein may be applied to the table above at any point, including after the table was modified, e.g., additional rows related to additional dimensions or entities of an organization are added or when rows are removed.

In some cases, a delay in availability of data may occur. For example, a report of headcount from one or more departments may not be available at a given time.

In accordance with an embodiment of the invention, if metric data is unavailable for a given period, the previous period's data metric values may be used. In other embodiments in accordance with the invention, when data and/or a metric is unavailable, costs distribution may be derived by fixed percentages. If when calculating a cost distribution a data metric value (e.g., headcount) is missing, an embodiment in accordance with the invention may be configured to recalculate a cost distribution upon such data becoming available. When the missing data arrives in the data warehouse, the allocation engine described herein may automatically reprocess and/or apply rules to an updated table, and a cost distribution may be calculated based on new metric data.

An entry in the table above or in another structure may be set to indicate that a calculation of cost distribution was performed based on old data. Upon receiving updated data the cost distribution may be recalculated using the updated data. A user may trigger a cost distribution calculation at any point in time. A user-initiated calculation may first update a relevant table (e.g., the table above) and then perform the calculation. A user may trigger a cost distribution calculation when data in the dataware is current.

A combination of metric based rules and other parameters may be defined in order to distribute costs. For example, a user may define a rule that distributes a cost between a subset of departments or other entities in an organization and further distributes the cost according to a metric. For example, there may be headcount metric information for 50 departments within a company, but a particular metric, such as power consumption within a specific building, may need to be distributed to the three departments that occupy that building. Accordingly, a rule may be created such that the power cost is associated with those three departments, and the cost is further distributed proportionally (based on metric values) to those departments.

In an embodiment in accordance with the invention, a user may define a metric without associating a dimension such as organization or location to the rule. A metric based rule may define a cost to be divided based on a headcount metric for any dimension. In such case, if a new department, location, and/or other dimension is added to an organization, the related cost may be automatically allocated to such new dimension based on its respective metric value. For example, a rule may define that the cost of IT services may be distributed to a dimension of an organization based on a headcount metric. Accordingly, if after such rule is defined a new department is added to the organization, such new department may be automatically billed its share of the IT services cost based on its headcount.

FIGS. 3-6 depict various exemplary GUIs 42 of an allocation application interface in accordance with an embodiment if the invention that may be used to configure scenarios, stages, and/or rules. Although particular types of inputs (e.g., check boxes, drop-down menu, etc.) are shown in these examples, it should be understood that these examples are not meant to be limiting, and various types of inputs may be used in various locations to accomplish various goals.

The GUI 42 of FIG. 3 may be used to configure a scenario. A progress indicator 43 may be provided to indicate the processing status of the scenario, as well as the time the scenario was started and the duration of time required to process the scenario. Processing on this scenario may be complete (as indicated by ?????), thus, the allocation engine may not currently be operating. When the allocation engine may be working on a scenario, the progress indicator 43 may indicate the percentage complete, as well as the start time and duration.

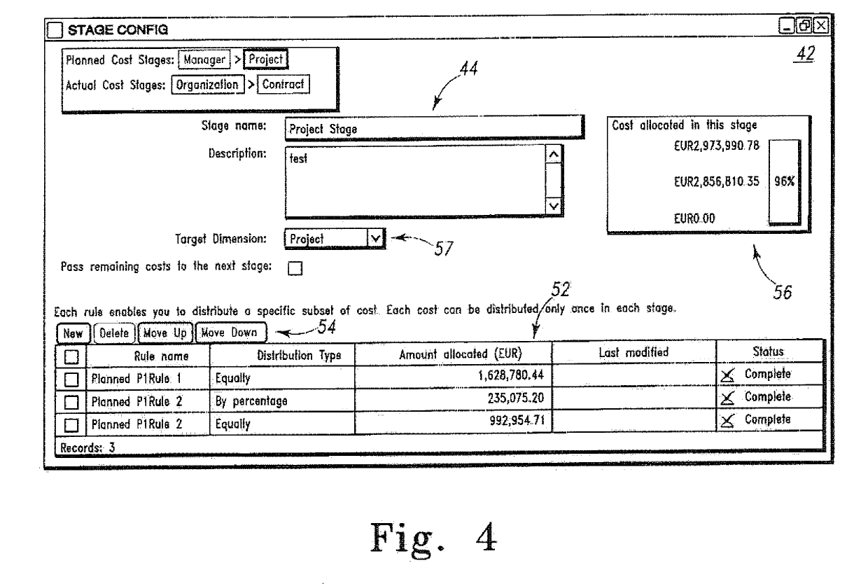

A scenario may be given a name and/or a description using name and description inputs 44. Date inputs 46 may also be included for providing start and/or end dates that may be used to limit the scope of data processing for a scenario. A series of stages 48 called “Planned Cost Stages” may be shown at the bottom and may include two stages: “Manager Stage” and “Project Stage.” A user may select stage name to pull up a GUI such as the one shown in FIG. 4 to edit the stage. A user also may be able to reorder stages using sequence inputs 50.

A publishing status box 51 also may be provided. It may indicate whether the results of the scenario as processed by the allocation engine have been published back to the data warehouse (e.g., by downstream ETL component 36). Publishing may be asynchronous relative to the GUI 42, and publishing status box 51 may display values such as “Unpublished,” Publication Requested,” “Publish in Progress” and “Publish Complete.”

FIG. 4 depicts an example GUI 42 for configuring a stage. As was the case with the GUI 42 for configuring scenarios of FIG. 3, a stage may be given a name and a description using name and description inputs 44. Stage-configuration GUI 42 also includes a series of rules 52 and rule sequence inputs 54 that may be used to edit and reorder rules within a stage, respectively.

Each rule in the series of rules 52 may include an “Amount Allocated” column that indicates to a user the amount of resources that are allocated according to the source criteria of that particular rule. Each rule in the series of rules 52 also may include a “Status” column, which may indicate to the user the progress of the series of rules 52. For example, a rule may have a status of “Draft,” “Reserving,” “Allocating,” and “Complete.”

Reserving resources (e.g., steps 102 and 108 of FIG. 2) may only require a moderate amount of computing resources. In contrast, allocating and reallocating reserved data (e.g., steps 104 and 108 of FIG. 2) may be resource-intensive. Accordingly, reserving and allocating may be executed separately and asynchronously. Thus, a user may be able to view the resources that are going to be reserved for allocation without having to wait for the actual allocation to be completed, which may occur some time later. To this end, an allocation indicator 56 may be provided that displays a sum of resources that are reserved during the present stage, prior to allocating the reserved resources into the working allocation table or back into the data warehouse.

In some embodiments, rules may be limited globally within a stage to reserve records of resources that are related to a particular dimension. For example, in FIG. 4, the GUI 42 includes a drop-down menu 57 labeled “Target dimension.” Drop-down menu 57 is used here to limit processing by the allocation engine of rules in this stage to records of resources having a “Project” dimension. Other stages of the same scenario may be directed to other dimensions. Accordingly, a user may cross reference resources between disparate data sources by chaining together a sequence of stages, each directed to a different dimension.

The stage configuration GUI 42 of FIG. 4 also includes an input labeled “Pass remaining costs to the next stage”. This input may be used to insert a catch-all rule such as the ones described in the application example above into the series of rules 52, typically in the last position.

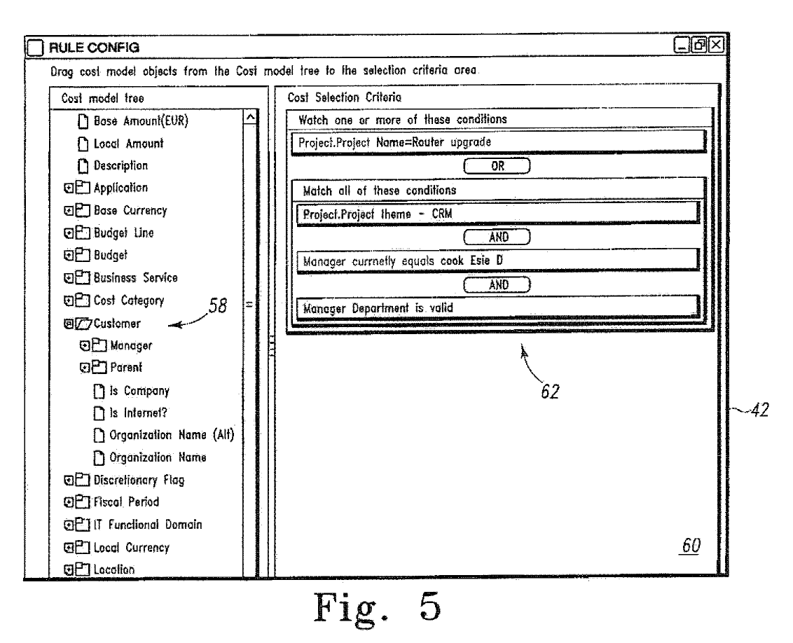

FIG. 5 depicts a GUI 42 that may be used to configure a rule. GUI 42 may include data dimension sources 58 that may be dragged and dropped onto a design area 60 in order to create and manipulate graphical representations 62 of rules, These graphical representations 62 may be usable to define source criteria that determine which records have resources that are to be reserved.

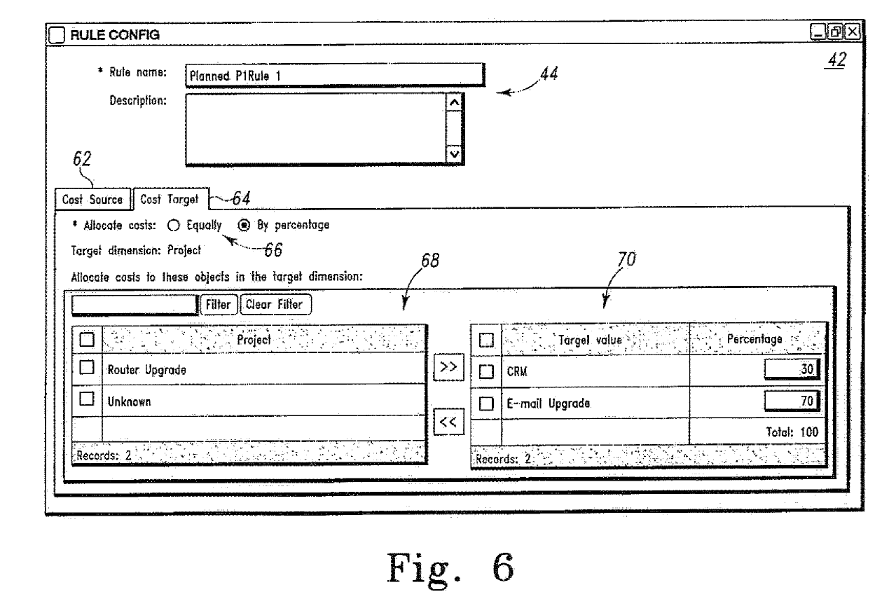

FIG. 6 depicts another GUI 42 that may be used to configure rules, and is more specifically tailored to configure source and target criteria of a rule that dictate from where resources are reserved and to where resources are allocated. Again, name and description inputs 44 are provided. A cost source edit area 62 and a cost target edit area 64 are provided to edit the source and target criteria, respectively, of a particular rule. The cost target edit area 64 is active here and includes inputs 66 for choosing a method of allocation of resources among multiple targets. In this example, the choices are “Equally” and “By percentage,” but other possibilities are contemplated herein.

Potential targets 68 may be provided that may be specific to a particular target dimension. In this example, each potential target is related to the “project” dimension. Selected targets 70 may be chosen from these potential targets 68 to dictate where resources are to be allocated. For each selected target 70, an amount of the resource that is to be allocated to the selected target may be defined (assuming the resource is not being allocated equally).

The disclosure set forth above may encompass multiple distinct embodiments with independent utility. The specific embodiments disclosed and illustrated herein are not to be considered in a limiting sense, because numerous variations are possible. The subject matter of this disclosure includes all novel and non-obvious combinations and subcombinations of the various elements, features, functions, and/or properties disclosed herein. The following claims particularly point out certain combinations and subcombinations regarded as novel and non-obvious. Other combinations and subcombinations of features, functions, elements, and/or properties may be claimed in applications claiming priority from this or a related application. Such claims, whether directed to a different embodiment or to the same embodiment, and whether broader, narrower, equal, or different in scope to the original claims, also are regarded as included within the subject matter of the present disclosure.

Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A method of allocating resources in a data warehouse, comprising:
determining a plurality of values of a selected metric for each of a respective plurality of records, each record related to a respective dimension selected from a set of dimensions of an enterprise;
and
allocating a first resource into one or more records of a working allocation table pursuant to a first rule related to the selected metric.

2. The method of claim 1, further comprising storing said records of said working allocation table in a data warehouse.

3. The method of claim 1, wherein said metric is at least one of a headcount, a server space consumption, a number of servers, a network nodes number, a network bandwidth, a number of service requests, and a size of a location.

4. The method of claim 1, comprising:
receiving data related to at least one of said dimensions;
determining at least one value of said selected metric for at least one of said dimensions;
associating said at least one value with said at least one of said dimensions; and
reallocating said first resource into said one or more records pursuant to said first rule.

5. The method of claim 1, comprising:
receiving data related to an additional dimension not included in said set of dimensions;
determining a value of said selected metric for said additional dimension;
associating said value with an additional record related to said additional dimension; and
reallocating said first resource into said one or more records and said additional record pursuant to said first rule.

6. The method of claim 1, wherein said values are associated with a time period, and said resource is allocated to said dimensions according to said time period.

7. The method of claim 1, comprising:
determining a second value for each of said records according to a second metric;
associating said second value with a respective dimension associated with each of said records; and
allocating said first resource into said one or more records pursuant to said first rule and a second rule related to said second metric.

8. A computer readable medium having stored thereon instructions which when executed by a processor cause the processor to perform the method of:
determining a plurality of values of a selected metric for each of a respective plurality of records, each record related to a respective dimension selected from a set of dimensions of an enterprise;
and
allocating a first resource into one or more records of a working allocation table pursuant to a first rule related to the selected metric.

9. The computer readable medium of claim 8, the instructions further including storing said records of said working allocation table in a data warehouse.

10. The computer readable medium of claim 8, wherein said metric is at least one of a headcount, a server space consumption, a number of servers, a network nodes number, a network bandwidth, a number of service requests, and a size of a location.

11. The computer readable medium of claim 8, the instructions further including:
receiving data related to at least one of said dimensions;
determining at least one value of said selected for at least one of said dimensions;
associating said at least one value with said at least one of said dimensions; and
reallocating said first resource into said one or more records pursuant to said first rule.

12. The computer readable medium of claim 8, the instructions further including:
receiving data related to an additional dimension not included in said set of dimensions;
determining a value of said selected metric for said additional dimension;
associating said value with an additional record related to said additional dimension; and
reallocating said first resource into said one or more records and said additional record pursuant to said first rule.

13. The computer readable medium of claim 8, wherein said values are associated with a time period, and said resource is allocated to said dimensions according to said time period.

14. The computer readable medium of claim 8, the instructions further including:
determining a second value for each of said records according to a second metric;
associating said second value with a respective dimension associated with each of said records; and
allocating said first resource into said one or more records pursuant to said first rule and a second rule related to said second metric.

15. A system comprising:
an application engine configured to:
determine a plurality of values of a selected metric for each of a respective plurality of records, each record related to a respective dimension selected from a set of dimensions of an enterprise;
and
allocate a first resource into one or more records of a working allocation table pursuant to a first rule related to the selected metric.
